(19) United States
(12) Patent Application Publication
(10) Pub. No.: US 2026/0125949 A1
(43) Pub. Date: May 7, 2026

(54) ACCESS PANEL

(71) Applicant: MYT Enterprises LLC, Lakewood, NJ (US)

(72) Inventor: Menachem Treff, Lakewood, NJ (US)

(73) Assignee: MYT Enterprises LLC, Lakewood, NJ (US)

(21) Appl. No.: 19/380,862

(22) Filed: Nov. 5, 2025

Related U.S. Application Data
(60) Provisional application No. 63/716,449, filed on Nov. 5, 2024.

(51) Int. Cl. E06B 7/28

(52) U.S. Cl. CPC E06B 7/28

(57) ABSTRACT

An access panel includes a planar sheet with a metallic inner surface designed to cover holes in walls, ceilings, or floors, allowing access to concealed infrastructure such as wiring and plumbing. It uses a magnetic attachment system that enables quick, tool-free installation, with magnets that can be adjusted around the hole's perimeter for optimal alignment and support. The magnetic attachment system eliminates the need for screws or hinges, preserving surrounding surfaces from wear or damage. With the flexibility to adjust magnet placement based on panel size and weight, this access panel is adaptable for diverse environments and offers aesthetic benefits, as it lacks visible fasteners and seamlessly blends into its surroundings.

### FIELD OF THE INVENTION

This application claims priority to U.S. Provisional Patent Application Serial No. 63/716,449 filed on November 5, 2024, entitled “Access Panel”, the disclosure and drawings of which are hereby incorporated herein in their entirety by reference.

### FIELD OF THE INVENTION

This invention relates to access panels, and more specifically, an access panel that utilizes magnetic attraction for attachment to a wall, ceiling or floor.

### BACKGROUND OF THE INVENTION

Access panels are practical solutions used to provide convenient access to hidden building components such as electrical wiring, plumbing, and HVAC systems without compromising the overall aesthetics of a space. Typically installed in walls, ceilings, or floors, they allow for easy maintenance and repairs by creating entry points to these concealed areas. Access panels can be formed from various material types for ensuring functionality. They are especially valuable in commercial and residential construction, reducing the need for destructive cutting or extensive remodeling when servicing critical systems.

While access panels offer convenience and practicality, they can present several problems if not properly installed or maintained. One common issue is poor placement, which can hinder access rather than facilitate it, particularly if the panel is too small or located in an awkward position. Improper sealing of access panels can also lead to air or water leaks, potentially causing damage to surrounding structures. Aesthetic concerns may arise if the panels do not blend well with the design of the space, detracting from the overall appearance. Ensuring proper selection and installation is critical to minimizing these issues, which requires valuable time.

Accordingly, there exists a need for an access panel which utilizes a metallic inner surface and magnetic attachment system, providing a secure, easily removable cover that simplifies installation and maintenance without compromising the structural integrity or aesthetics of surrounding surfaces.

### SUMMARY OF THE INVENTION

In accordance with one form of the invention, there is provided an access panel includes a planar sheet with a metallic inner surface designed to cover holes in walls, ceilings, or floors, allowing access to concealed infrastructure such as wiring and plumbing. It uses a magnetic attachment system that enables quick, tool-free installation, with magnets that can be adjusted around the hole's perimeter for optimal alignment and support. The magnetic attachment system eliminates the need for screws or hinges, preserving surrounding surfaces from wear or damage. With the flexibility to adjust magnet placement based on panel size and weight, this access panel is adaptable for diverse environments and offers aesthetic benefits, as it lacks visible fasteners and seamlessly blends into its surroundings.

### BRIEF DESCRIPTION OF THE DRAWINGS

For a fuller understanding of the nature of the present invention, reference should be made to the following detailed description, taken in conjunction with the accompanying drawings in which:

FIG. 1 is a perspective view of a planar sheet of an access panel, according to one embodiment, covering a hole;

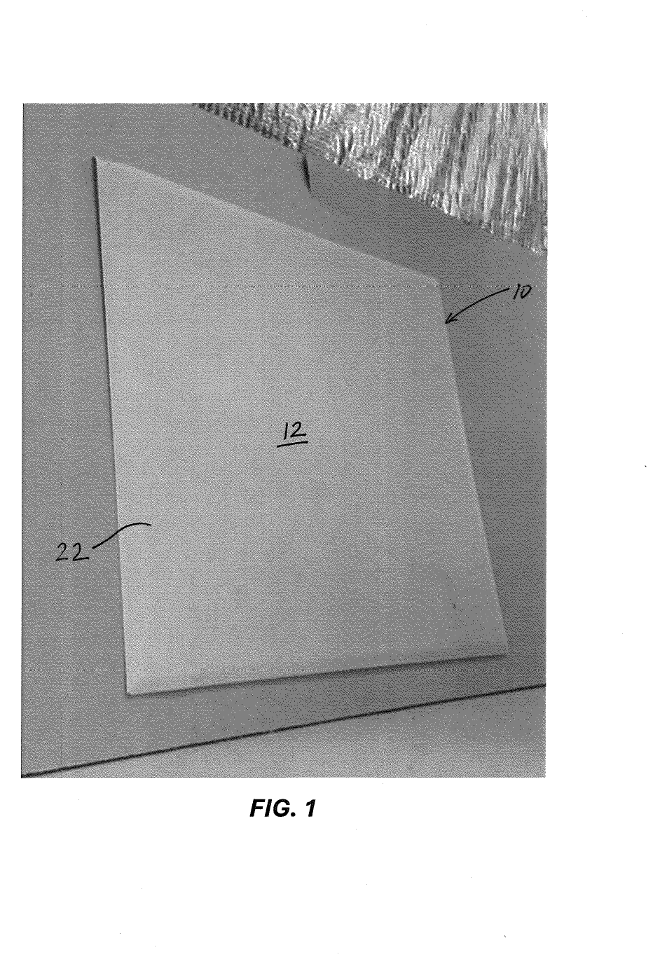

FIG. 2 is a perspective view of a plurality of magnets secured to the perimeter of a hole; and

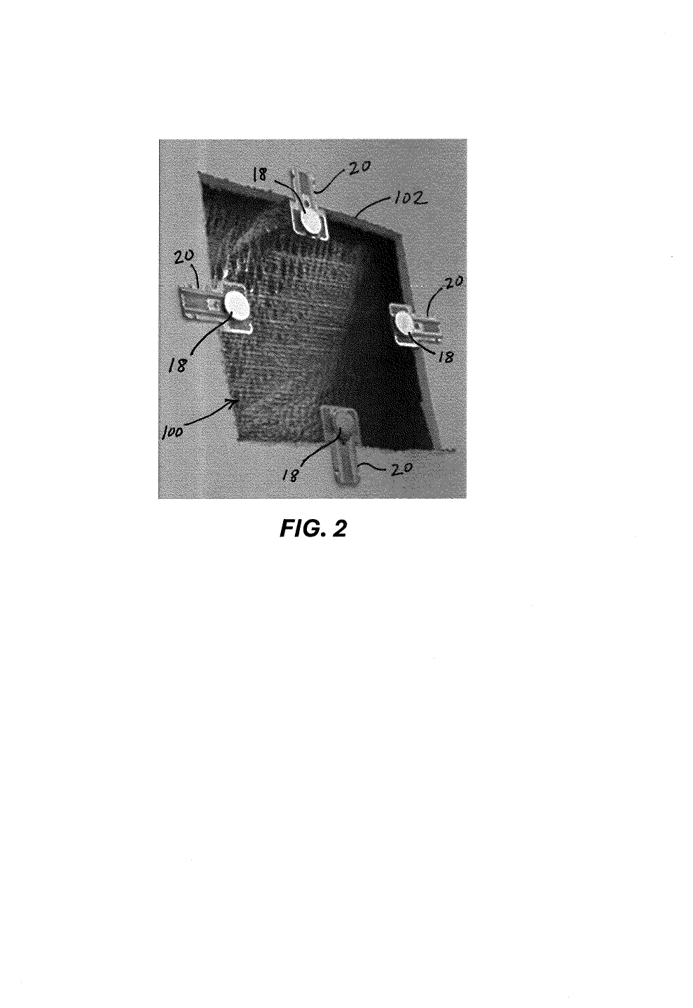

FIG. 3 is a perspective view of the dual cannister foaming apparatus shown in cross-section.

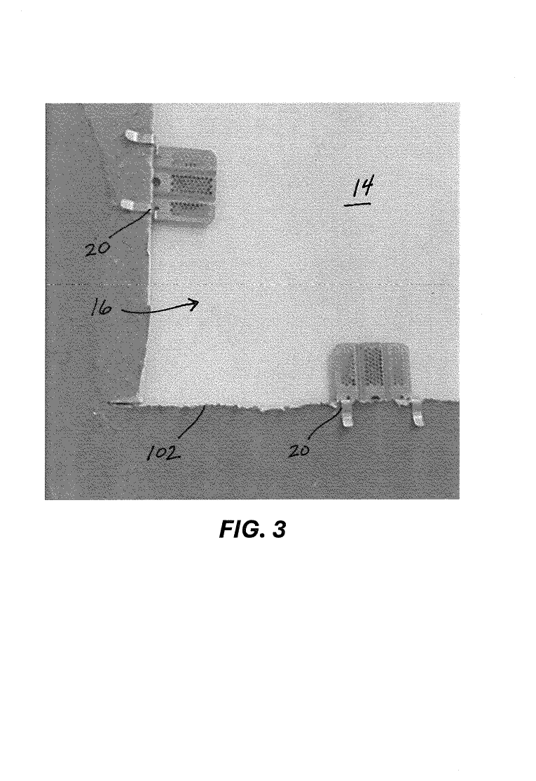

Like reference numerals refer to like reference parts throughout the several views of the drawings.

### DETAILED DESCRIPTION

Referring to the several views of the drawings, the access panel is shown and described herein, and is generally indicated as 10.

The access panel 10 includes a planar sheet 12 having a metallic inner facing surface 14. The access panel 10 is intended to cover holes 100 in walls, ceilings, or floors, providing a non-intrusive yet easily removable barrier for accessing concealed infrastructure such as electrical wiring, plumbing, or HVAC components, and relies on a magnetic attachment system to secure it in place. The inner facing surface 14 of the panel 10 is made from or coated with a metallic material 16, allowing for magnetic engagement. A plurality of magnets 18 can be selectively positioned around the perimeter 102 of a hole 100, offering a flexible and tool-free installation method.

According to an embodiment, the magnets 18 may each be secured to a securing device, such as a clip 20, which, in turn, may be secured to the perimeter 102 of the hole 100.

The use of magnets permits adjustability and ease of installation. Users are able to affix magnets 18 around the perimeter 102 of the hole 100, adjusting their placement as necessary to achieve optimal support and alignment of the access panel 10. Once the magnets are in position, the metallic inner surface 14 of the planar sheet 12 adheres securely to them, covering the hole 100. This magnetic attachment system eliminates the need for screws, hinges, or other mechanical fasteners, which can be cumbersome to install and remove. The magnetic connection also allows for rapid access when needed, enabling the panel to be removed and replaced repeatedly without wear to the surrounding wall, ceiling, or floor.

The access panel 10 also offers significant flexibility for various building environments. The number of magnets – and therefore the strength of the magnetic connection – can be selected based on the size of the hole and the weight of the access panel, making it suitable for a wide range of applications. Moreover, the use of magnets reduces the risk of misalignment, a common issue with traditional access panels that require precise screw or latch placements. Additionally, because the panel 10 can be securely held in place without penetrating the surface around the hole 100, the integrity of the surrounding material is preserved, reducing the likelihood of cracks or damage over time.

A potential benefit of the metallic surface and magnetic attachment system is aesthetic versatility. Since the planar sheet 12 of the panel 10 is not fixed permanently and lacks external fasteners, it can be easily removed, allowing for adjustments to its appearance or finish without compromising its functionality. This feature is particularly advantageous in spaces where design continuity is important. The exposed, outer facing surface 22 of the planar sheet 12 afforded by the magnetic system ensures that the access panel 10 blends into its surroundings without distracting from the overall aesthetics of the area.

An access panel 10 for covering a hole 100 in a wall, ceiling, or floor, includes a planar sheet 12 having a metallic inner surface 14; a plurality of magnets 18 configured for selective placement around a perimeter 102 of the hole 100; wherein the metallic inner surface 14 is adapted to magnetically engage with the magnets 18 to secure the planar sheet 12 over the hole 100; wherein the magnets 18 are adjustable in position to provide optimal alignment and support for the planar sheet 12; and wherein the access panel 10 is removable without the use of tools, thereby preserving the integrity of the surrounding surface.

The access panel 10 described above may further include features such as each magnet 18 being secured to a clip 20, with each clip 20 attachable to the perimeter 102 of the hole 100. The number and placement of magnets 18 may be selected based on the size and weight of the planar sheet 12. The planar sheet 12 may lack visible fasteners on its outer surface 22, and the metallic inner surface 14 may be coated with a corrosion-resistant material 16. The access panel 10 may be adapted for use in both commercial and residential environments, with the magnets 18 configured to be repositioned to accommodate holes 100 of varying shapes and sizes, and the planar sheet 12 configured to blend aesthetically with the surrounding surface.

A method of installing an access panel 10 includes positioning a plurality of magnets 18 around a perimeter 102 of a hole 100 in a wall, ceiling, or floor; adjusting the magnets 18 to achieve optimal alignment and support; placing a planar sheet 12 having a metallic inner surface 14 over the hole 100 such that the metallic inner surface 14 magnetically engages with the magnets 18; and removing the planar sheet 12 as needed without the use of tools.

While the present invention has been shown and described in accordance with several preferred and practical embodiments, it is recognized that departures from the instant disclosure are contemplated within the spirit and scope of the present invention.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top, and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

The subject matter described herein is provided by way of illustration only and should not be construed as limiting the nature and scope of the subject invention. While examples of aspects of the subject invention have been provided above, it is not possible to describe every conceivable combination of components or methodologies for implementing the subject invention, and one of ordinary skill in the art may recognize that further combinations and permutations of the subject invention are possible. Furthermore, the subject invention is not necessarily limited to implementations that solve any or all disadvantages which may have been noted in any part of this disclosure. Various modifications and changes may be made to the subject invention described herein without following, or departing from the spirit and scope of, the exemplary embodiments and applications illustrated and described herein. Although the subject matter presented herein has been described in language specific to components used therein, it is to be understood that the subject invention is not necessarily limited to the specific components or characteristics thereof described herein; rather, the specific components and characteristics thereof are disclosed as example forms of implementing the subject invention. Accordingly, the disclosed subject matter is intended to embrace all alterations, modifications, and variations, that fall within the scope and spirit of any claims that are written, or may be written, for the subject invention.

What is claimed is:

1. An access panel for covering a hole in a wall, ceiling, or floor, the access panel comprising:
a planar sheet having a metallic inner surface;
a plurality of magnets configured for selective placement around a perimeter of the hole;
wherein the metallic inner surface is adapted to magnetically engage with the magnets to secure the planar sheet over the hole;
wherein each magnet of the plurality of magnets is adjustable in position to provide optimal alignment and support for the planar sheet; and
wherein the access panel is removable without the use of tools.

2. The access panel of claim 1, wherein each magnet of the plurality of magnets is secured to a clip, and wherein the clip is attachable to the perimeter of the hole.

3. The access panel of claim 1, wherein the number and placement of magnets are selected based on the size and weight of the planar sheet.

4. The access panel of claim 1, wherein the planar sheet lacks visible fasteners on its outer surface.

5. The access panel of claim 1, wherein the metallic inner surface is coated with a corrosion-resistant material.

6. The access panel of claim 1, wherein each magnet of the plurality of magnets are configured to be repositioned to accommodate holes of varying shapes and sizes.

7. The access panel of claim 1, wherein the planar sheet is configured to blend aesthetically with the surrounding surface.

8. A method of installing an access panel comprising:
positioning a plurality of magnets around a perimeter of a hole in a wall, ceiling, or floor;
adjusting the magnets to achieve optimal alignment and support;
placing a planar sheet having a metallic inner surface over the hole such that the metallic inner surface magnetically engages with the magnets; and
removing the planar sheet as needed without the use of tools.
